(19) United States
(12) Patent Application Publication
(10) Pub. No.: US 2005/0035590 A1
(43) Pub. Date: Feb. 17, 2005

(54) Identification document usable with D2T2 printing

(76) Inventors: Robert L. Jones, Andover, MA (US); Brian Labrec, North Oxford, MA (US); Daoshen Bi, Boxborough, MA (US); Thomas Regan, Seabrook, NH (US)

Correspondence Address: DIGIMARC CORPORATION, 9405 SW GEMINI DRIVE, BEAVERTON, OR, 97008, US

(21) Appl. No.: 10/848,526

(22) Filed: May 17, 2004

Related U.S. Application Data
(60) Provisional application No. 60/471,429, filed on May 16, 2003.
(60) Provisional application No. 60/488,536, filed on Jul. 17, 2003.

(51) Int. Cl. B42D 15/00

(52) U.S. Cl. 283/74

(57) ABSTRACT

The invention provides an identification document comprising a substantially opaque polycarbonate core layer bearing at least one indicium thereon, two layers of substantially transparent polycarbonate fixed to the core layer on opposed sides thereof, and at least one image-receiving layer capable of being imaged by dye diffusion thermal transfer, the image-receiving layer being fixed to one of the layers of substantially transparent polycarbonate on the side thereof remote from the core layer.

### RELATED APPLICATION DATA

This application claims priority to the following United States Provisional Applications, which are incorporated by reference in its entirety:

“Identification Document,” Ser. No. 60/471,429 Attorney Docket Number P0833D, inventors Robert Jones, Daoshen Bi, Tom Regan and Brian Labrec, filed on May 16, 2003;

“Uniquely Linking Security Elements in Identification Documents,” Ser. No. 60/488,536, Attorney Docket Number P0853D, inventors Robert Durst, Robert Jones, and Leo Kenen, filed Jul. 17, 2003.

This application is also related to the following United States patent Documents, each of which is hereby incorporated by reference in its entirety:

Laser Engraving Methods and Compositions, and Articles Having Laser Engraving Thereon (application Ser. No. 10/326,886, Attorney Docket No. P0724D, filed Dec. 20, 2002—Inventors Brian Labrec and Robert Jones);

Systems, Compositions, and Methods for Full Color Laser Engraving of ID Documents (application Ser. No. 10/330,034, Attorney Docket No. P0734D, filed Dec. 24, 2002—Inventor Robert Jones);

Laser Engraving Methods and Compositions, and Articles Having Laser Engraving Thereon,” (application Ser. No. 10/326,886, filed Dec. 20, 2002, attorney docket number P0724D, filed Mar. 17, 2004, inventors Robert Jones and Brian Labrec);

Laser Engraving Methods and Compositions and Articles Having Laser Engraving Thereon (application Ser. No. 10/803,538, Attorney Docket No. P0952D—Inventor Brian Labrec);

Laser Engraving Methods and Compositions and Articles Having Laser Engraving Thereon (Application No. 60/504352, Attorney Docket No. P0888D, filed Sep. 19, 2003—Inventors Brian Labrec and Robert Jones);

Increasing Thermal Conductivity of Host Polymer Used with Laser Engraving Methods and Compositions (application Ser. No. 10/677,092, Attorney Docket No. P0889D, filed Sep. 30, 2003);

Document Laminate Formed From Different Polyester Materials (application Ser. No. 10/692,463, Attorney docket Number P0901D, filed Oct. 22, 2003, Inventor Brian Labrec);

Contact Smart Cards Having a Document Core, Contactless Smart Cards Including Multi-Layered Structure, PET-Based Identification Document, and Methods of Making Same (application Ser. No. 10/836,639, Attorney Docket No. P0983D, filed Apr. 29, 2004—Inventors Robert Jones and Daoshen Bi; and

Identification Document having Intrusion Resistance (Application No. 50/558177, Attorney Docket No. P0957D, filed Mar. 26, 2004—Inventors Robert Jones, Daoshen Bi, Tung Feng Yeh);

Ink with Cohesive Failure and Identification Document Including Same (application Ser. No. 10/329,315, Attorney Docket No. P0714D, filed Dec. 23, 2002—Inventors Robert Jones and Bentley Bloomberg);

U.S. Pat. No. 6,066,594, entitled “Identification Document,” issued May 23, 2000, inventors Valerie E. Gunn and Janet M. Schaafner; and

U.S. Pat. No. 5,334,572, entitled “Sheet Material for Thermal Transfer Imaging,” issued Aug. 2, 1994, inventor Howard G. Schild.

### TECHNICAL FIELD

The present invention generally relates to storage of information on documents such as identification and security documents, and in particular, relates to identification document printing and assembly systems and methods,

### BACKGROUND AND SUMMARY

### Identification Documents

Identification documents (hereafter “ID documents”) play a critical role in today's society. One example of an ID document is an identification card (“ID card”). ID documents are used on a daily basis—to prove identity, to verify age, to access a secure area, to evidence driving privileges, to cash a check, and so on. Airplane passengers are required to show an ID document during check in, security screening, and prior to boarding their flight. In addition, because we live in an ever-evolving cashless society, ID documents are used to make payments, access an ATM, debit an account, or make a payment, etc.

(For the purposes of this disclosure, ID documents are broadly defined herein, and include, e.g., credit cards, bank cards, phone cards, passports, driver's licenses, network access cards, employee badges, debit cards, security cards, visas, immigration documentation, national ID cards, citizenship cards, social security cards, security badges, certificates, identification cards or documents, voter registration cards, police ID cards, border crossing cards, legal instruments, security clearance badges and cards, gun permits, gift certificates or cards, membership cards or badges, etc., etc. Also, the terms “document,” “card,” “badge” and “documentation” are used interchangeably throughout this patent application.).

As those skilled in the art know, ID documents such as drivers licenses can contain information such as a photographic image, a bar code (which may contain information specific to the person whose image appears in the photographic image, and/or information that is the same from ID document to ID document), variable personal information, such as an address, signature, and/or birthdate, biometric information associated with the person whose image appears in the photographic image (e.g., a fingerprint), a magnetic stripe (which, for example, can be on the a side of the ID document that is opposite the side with the photographic image), and various security features, such as a security pattern (for example, a printed pattern comprising a tightly printed pattern of finely divided printed and unprinted areas in close proximity to each other, such as a fine-line printed security pattern as is used in the printing of banknote paper, stock certificates, and the like).

Many types of identification cards and documents, such as driving licenses, national or government identification cards, bank cards, credit cards, controlled access cards and smart cards, carry thereon certain items of information which relate to the identity of the bearer. Examples of such information include name, address, birth date, signature and photographic image; the cards or documents may in addition carry other variant data (i.e., data specific to a particular card or document, for example an employee number) and invariant data (i.e., data common to a large number of cards, for example the name of an employer). All of the cards described above will hereinafter be generically referred to as “ID documents”.

In the production of images useful in the field of identification documentation, it is oftentimes desirable to embody into a document (such as an ID card, drivers license, passport or the like) data or indicia representative of the document issuer (e.g., an official seal, or the name or mark of a company or educational institution) and data or indicia representative of the document bearer (e.g., a photographic likeness, name or address). Typically, a pattern, logo or other distinctive marking representative of the document issuer will serve as a means of verifying the authenticity, genuineness or valid issuance of the document. A photographic likeness or other data or indicia personal to the bearer will validate the right of access to certain facilities or the prior authorization to engage in commercial transactions and activities.

Identification documents, such as ID cards, having printed background security patterns, designs or logos and identification data personal to the card bearer have been known and are described, for example, in U.S. Pat. No. 3,758,970, issued Sep. 18, 1973 to M. Annenberg; in Great Britain Pat. No. 1,472,581, issued to G. A. O. Gesellschaft Fur Automation Und Organisation mbH, published Mar. 10, 1976; in International Patent Application PCT/GB82/00150, published Nov. 25, 1982 as Publication No. WO 82/04149; in U.S. Pat. No. 4,653,775, issued Mar. 31, 1987 to T. Raphael, et al.; in U.S. Pat. No. 4,738,949, issued Apr. 19, 1988 to G. S. Sethi, et al.; and in U.S. Pat. No. 5,261,987, issued Nov. 16 1993 to J. W. Luening, et al. All of the aforementioned documents are hereby incorporated by reference. Laminated ID documents are used as certificates of citizenship, identification cards, driver's licenses, member cards, passports, transaction cards, national identification cards, etc., etc., etc.

### Printing Information onto ID Documents

The advent of commercial apparatus (printers) for producing dye images by thermal transfer has made relatively commonplace the production of color prints from electronic data acquired by a video camera. In general, this is accomplished by the acquisition of digital image information (electronic signals) representative of the red, green and blue content of an original, using color filters or other known means. These signals are then utilized by a printer having a plurality of small heating elements (e.g., pins) for imagewise heating of each of a series of donor sheets (respectively, carrying sublimable cyan, magenta and yellow dye). The donor sheets are brought into contact with an image-receiving element (which can, for example, be a substrate) which has a layer for receiving the dyes transferred imagewise from the donor sheets. Thermal dye transfer methods as aforesaid are known and described, for example, in U.S. Pat. No. 4,621,271, issued Nov. 4, 1986 to S. Brownstein and U.S. Pat. No. 5,024,989, issued Jun. 18, 1991 to Y. H. Chiang, et al. Each of these patents is hereby incorporated by reference.

Dye diffusion thermal transfer printing (“D2T2”) and thermal transfer (also referred to as mass transfer printing) are two printing techniques that have been used to print information on identification cards. For example, D2T2 has been used to print images and pictures, and thermal transfer has been used to print text, bar codes, and single color graphics.

D2T2 is a thermal imaging technology that allows for the production of photographic quality images. In D2T2 printing, one or more thermally transferable dyes (e.g., cyan, yellow, and magenta) are transferred from a donor, such as a donor dye sheet or a set of panels (or ribbons) that are coated with a dye (e.g., cyan, magenta, yellow, black, etc.) to a receiver sheet (which could, for example, be part of an ID document) by the localized application of heat or pressure, via a stylus or thermal printhead at a discrete point. When the dyes are transferred to the receiver, the dyes diffuse into the sheet (or ID card substrate), where the dyes will chemically be bound to the substrate or, if provided, to a receptor coating. Typically, printing with successive color panels across the document creates an image in or on the document's surface. D2T2 can result in a very high printing quality, especially because the energy applied to the thermal printhead can vary to vary the dye density in the image pixels formed on the receiver, to produce a continuous tone image. D2T2 can have an increased cost as compared to other methods, however, because of the special dyes needed and the cost of D2T2 ribbons. Also, the quality of D2T2-printed image may depend at least on an ability of a mechanical printer system to accurately spatially register a printing sequence, e.g., yellow, magenta, cyan, and black.

Another thermal imaging technology is thermal or mass transfer printing. With mass transfer printing, a material to be deposited on a receiver (such as carbon black (referred to by the symbol “K”)) is provided on a mass transfer donor medium. When localized heat is applied to the mass transfer donor medium, a portion (mass) of the material is physically transferred to the receiver, where it sits “on top of” the receiver. For example, mass transfer printing often is used to print text, bar codes, and monochrome images. Resin black mass transfer has been used to print grayscale pictures using a dithered gray scale, although the image can sometimes look coarser than an image produced using D2T2. However, mass transfer printing can sometimes be faster than D2T2, and faster printing can be desirable in some situations.

Printing of black (“K”) can be accomplished using either D2T2 or mass transfer. For example, black monochrome “K” mass transfer ribbons include Kr (which designates a thermal transfer ribbon) and Kd (which designates dye diffusion).

Both D2T2 and thermal ink have been combined in a single ribbon, which is the well-known YMCK (Yellow-Magenta-Cyan-Black) ribbon (the letter “K” is used to designate the color black in the printing industry). Another panel containing a protectant (“P”) or laminate (typically a clear panel) also can be added to the YMCK ribbon).

### Manufacture and Printing Environments

Commercial systems for issuing ID documents are of two main types, namely so-called “central” issue (CI), and so-called “on-the-spot” or “over-the-counter” (OTC) issue.

CI type ID documents are not immediately provided to the bearer, but are later issued to the bearer from a central location. For example, in one type of CI environment, a bearer reports to a document station where data is collected, the data are forwarded to a central location where the card is produced, and the card is forwarded to the bearer, often by mail. Another illustrative example of a CI assembling process occurs in a setting where a driver passes a driving test, but then receives her license in the mail from a CI facility a short time later. Still another illustrative example of a CI assembling process occurs in a setting where a driver renews her license by mail or over the Internet, then receives a drivers license card through the mail.

In contrast, a CI assembling process is more of a bulk process facility, where many cards are produced in a centralized facility, one after another. (For example, picture a setting where a driver passes a driving test, but then receives her license in the mail from a CI facility a short time later. The CI facility may process thousands of cards in a continuous manner.).

Centrally issued identification documents can be produced from digitally stored information and generally comprise an opaque core material (also referred to as “substrate”), such as paper or plastic, sandwiched between two layers of clear plastic laminate, such as polyester, to protect the aforementioned items of information from wear, exposure to the elements and tampering. The materials used in such CI identification documents can offer the ultimate in durability. In addition, centrally issued digital identification documents generally offer a higher level of security than OTC identification documents because they offer the ability to pre-print the core of the central issue document with security features such as “micro-printing”, ultra-violet security features, security indicia and other features currently unique to centrally issued identification documents.

In addition, a CI assembling process can be more of a bulk process facility, in which many cards are produced in a centralized facility, one after another. The CI facility may, for example, process thousands of cards in a continuous manner. Because the processing occurs in bulk, CI can have an increase in efficiency as compared to some OTC processes, especially those OTC processes that run intermittently. Thus, CI processes can sometimes have a lower cost per ID document, if a large volume of ID documents are manufactured.

In contrast to CI identification documents, OTC identification documents are issued immediately to a bearer who is present at a document-issuing station. An OTC assembling process provides an ID document “on-the-spot”. (An illustrative example of an OTC assembling process is a Department of Motor Vehicles (“DMV”) setting where a driver's license is issued to person, on the spot, after a successful exam.). In some instances, the very nature of the OTC assembling process results in small, sometimes compact, printing and card assemblers for printing the ID document. It will be appreciated that an OTC card issuing process is by its nature can be an intermittent—in comparison to a continuous—process.

OTC identification documents of the types mentioned above can take a number of forms, depending on cost and desired features. Some OTC ID documents comprise highly plasticized poly(vinyl chloride) or have a composite structure with polyester laminated to 0.5-2.0 mil (13-51 .mu.m) poly(vinyl chloride) film, which provides a suitable receiving layer for heat transferable dyes which form a photographic image, together with any variant or invariant data required for the identification of the bearer. These data are subsequently protected to varying degrees by clear, thin (0.125-0.250 mil, 3-6 .mu.m) overlay patches applied at the printhead, holographic hot stamp foils (0.125-0.250 mil 3-6 .mu.m), or a clear polyester laminate (0.5-10 mil, 13-254 .mu.m) supporting common security features. These last two types of protective foil or laminate sometimes are applied at a laminating station separate from the printhead. The choice of laminate dictates the degree of durability and security imparted to the system in protecting the image and other data.

Digital OTC identification documents of the types mentioned above are generally comprised of highly plasticized poly(vinyl chloride) or have a composite structure with polyester laminated to highly plasticized 0.5-2.0 mil (13-51 .mu.m) poly(vinyl chloride) film, which provides a suitable receiving layer for heat transferable dyes which form a photographic image, together with any variant or invariant data required for the identification of the bearer. These data are subsequently protected to varying degrees by clear, thin (0.125-0.250 mil, 3-6 .mu.m) overlay patches applied at the printhead, holographic hot stamp foils (0.125-0.250 mil 3-6 .mu.m), or a clear polyester laminate (0.5-10 mil, 13-254 .mu.m) supporting common security features; these last two types of protective foil or laminate are applied at a laminating station separate from the printhead. The choice of laminate dictates the degree of durability and security imparted to the system in protecting the image and other data.

Although various types of OTC and CI, documents are in wide use throughout the world, at least some of them can suffer from several disadvantages. Both the highly plasticized poly(vinyl chloride) type and the polyester/poly(vinyl chloride) composite type can become embrittled over time because of migration of the plasticizers, thus reducing the resistance of the document to cracking; such cracking renders the card unusable and vulnerable to tampering. Data which may be crucial to the identification of the bearer can be covertly repeated on the document in encrypted form for data verification in a magnetic stripe, bar code, radio frequency module or integrated circuit chip. The inability to retrieve such data due to cracking renders the document invalid. In addition, many of the polyester/poly(vinyl chloride) composite documents have exhibited extreme sensitivity to combinations of heat and humidity, as evidenced by delamination and curling of the document structure.

One type of OTC identification document that sought to overcome at least some of these disadvantages is available from the assignee of the present invention is the card structure described in commonly assigned U.S. Pat. No. 6,066,594, and the contents of this patent are incorporated hereto by reference in their entirety. In at least one embodiment, the U.S. Pat. No. 6,066,594 patent describes manufacture of an identification card that can be produced as a “pre-printed” card blank, pre-cut to a desired size, and capable of being provided to an appropriate printer (e.g., a dye-diffusion-thermal printer, such as available from Atlantek Inc. of Wakefield, R.I., Fargo Electronics Inc. of Eden Prairie, Minn., Zebra Technologies (Eltron) of Camarillo, Calif., and Nisca of Somerset, N.J., and the like, printed by the printer, and output from the print as a finished printed, and optionally laminated identification card.

Embodiments of the invention provide improvements over known identification document structures. These improved identification documents can be used in both central issue and over the counter type identification document manufacturing and printing systems.

In one embodiment of the invention, an ID document can comprise a core layer sandwiched between two transparent layers. The core layer can be pre-printed. In one embodiment, the core layer is made from a light-colored, opaque material. In one embodiment, the core material is made from at least one of TESLIN (available from PPG Industries) or polycarbonate (PC) material. The core is laminated with a transparent material, such as clear PC to form a so-called “card blank”. An image receiving layer is deposited on the clear layer. Information, such as variable personal information (e.g., photographic information), can be printed on the card blank (via the receiving layer) using a method such as Dye Diffision Thermal Transfer (“D2T2”) printing also described in commonly assigned U.S. Pat. No. 6,066,594, which is incorporated herein by reference in its entirety. The information can, for example, comprise an indicium or indicia, such as the invariant or nonvarying information common to a large number of identification documents, for example the name and logo of the organization issuing the documents. The information may be formed by any known process capable of forming the indicium on the specific core material used.

To protect the information that is printed, an additional layer of transparent overlaminate can be coupled to the card blank and printed information, as is known by those skilled in the art. Illustrative examples of usable materials for overlaminates include biaxially oriented polyester or other optically clear durable plastic film.

In another embodiment of the invention, the invention provides an identification document comprising a TESLIN core layer bearing at least one indicium thereon, two layers of a substantially transparent polycarbonate fixed to the core layer on opposed sides thereof, and at least one image-receiving layer capable of being imaged by dye diffusion thermal transfer, the image-receiving layer being fixed to one of the layers of substantially transparent polycarbonate on the side thereof remote from the core layer.

In another embodiment of the invention, the invention provides an identification document comprising a substantially opaque polycarbonate core layer bearing at least one indicium thereon, two layers of substantially transparent polycarbonate fixed to the core layer on opposed sides thereof, and at least one image-receiving layer capable of being imaged by dye diffusion thermal transfer, the image-receiving layer being fixed to one of the layers of substantially transparent polycarbonate on the side thereof remote from the core layer.

In a further embodiment, the invention also provides a process for preparing an identification document, which process comprises:
forming at least one first indicium upon a core layer, core layer comprising at least one of TESLIN and substantially opaque polycarbonate;
affixing to the indicium-carrying core layer two layers of substantially transparent polycarbonate, one of these layers being affixed to each surface of the core layer; and
providing, on one of the layers of substantially transparent polycarbonate, on the side thereof remote from the core layer, an image-receiving layer capable of being imaged by dye diffusion thermal transfer.

In a further embodiment, the process includes printing by dye diffusion thermal transfer at least one second indicium on the image-receiving layer, this second indicium being different from the first indicium on the core layer. In a further embodiment, the process includes affixing a protective layer over the image-receiving layer bearing the second indicium.

In one embodiment, we provide an identification document comprising a core layer, a substantially transparent layer, and an image receiving layer. The core layer has first and second sides and comprises at least one of polycarbonate (PC) and polyethylene terephthalate (PET). The substantially transparent layer is fixed to the first side of the core layer and has first and second sides and affixed to the core layer along the first side of the substantially transparent layer. The substantially transparent layer comprises at least one of PC and PET. The image-receiving layer is capable of being imaged by dye diffusion thermal transfer and is fixed to the second side of the substantially transparent layer.

The image receiving layer can, for example, comprise polyvinyl chloride and can be applied as a coating. The core layer can have a first indicium formed thereon and the image receiving layer can have at least one second indicium printed thereon by dye diffusion thermal transfer. The indicium on the core layer can, for example, be formed by at least one of laser engraving, laser marking, and laser etching.

In another embodiment, we provide A process for preparing an identification document, which process comprises:
providing a core layer, the core layer having first and second sides and comprising at least one of polycarbonate (PC) and polyethylene terephthalate (PET);
affixing to the first side of the core layer a substantially transparent layer, the substantially transparent layer having first and second sides and affixed to the core layer along the first side of the substantially transparent layer, the substantially transparent layer comprising at least one of PC and PET; and
applying to the second side of the substantially transparent layer an image-receiving layer capable of being imaged by dye diffusion thermal transfer.

In still a further embodiment, we provide an identification document, comprising a core layer, the core layer having first and second sides and comprising at least one of polycarbonate and polyethylene terephthalate, and an image-receiving layer capable of being imaged by dye diffusion thermal transfer, the image-receiving layer being fixed to at least one of the first and second sides of the core layer.

The foregoing and other features and advantages of the present invention will be even more readily apparent from the following Detailed Description, which proceeds with reference to the accompanying drawings and the claims.

### BRIEF DESCRIPTION OF THE DRAWINGS

The advantages, features, and aspects of embodiments of the invention will be more fully understood in conjunction with the following detailed description and accompanying drawings, wherein:

FIG. 1 is an illustration of an identification document in accordance with a first embodiment of the invention;

FIG. 2 is a cross section of the identification document of FIG. 1, taken along the A-A line;

FIG. 3 is a perspective exploded view of the identification document of FIG. 1;

FIG. 4 is an illustrative cross sectional view of an identification document in accordance with a second embodiment of the invention;

FIG. 5 is an illustrative cross sectional view of an identification document in accordance with a third embodiment of the invention; and

FIG. 6 is an illustrative cross-sectional view of an identification document in accordance with a fourth embodiment of the invention.

Of course, the drawings are not necessarily drawn to scale, with emphasis rather being placed upon illustrating the principles of the invention. In the drawings, like reference numbers indicate like elements or steps. Further, throughout this application, certain indicia, information, identification documents, data, etc., may be shown as having a particular cross sectional shape (e.g., rectangular) but that is provided by way of example and illustration only and is not limiting, nor is the shape intended to represent the actual resultant cross sectional shape that occurs during manufacturing of identification documents.

### DETAILED DESCRIPTION

In the foregoing discussion, the use of the word “card” is intended to include all types of ID documents. (For the purposes of this disclosure, the terms “document,” “card,” “badge” and “documentation” are used interchangeably. In addition, ID document shall include, without limitation, documents, magnetic disks, CD's, or any other suitable items that may record information, images, and/or other data, which may be associated with an object or other entity to be identified.) Further, it should be appreciated that although the some of the figures illustrate a particular species of ID document—a driver's license—the present invention is not so limited. Indeed our inventive methods and techniques apply generally to all identification documents defined above.

As used herein, an “information-bearing layer” refers at least to the parts of an ID document where pictures, images, text, bar codes, fixed and/or variable data are printed. The information-bearing layer can include a separate receiver layer adapted to accept inks, dyes, pigments and resins from thermal print ribbons. The information-bearing layer can itself be the receiver layer. Depending on the particular design of the ID document, the information bearing layer can be the substrate or core layer, but also can be a laminate applied thereto, or to another laminate layer on the card. There can be different information bearing layers in an ID document for pre-printing and for personalization.

In the foregoing discussion, the use of the word “ID document” is broadly defined and intended to include all types of ID documents, including (but not limited to), documents, magnetic disks, credit cards, bank cards, phone cards, stored value cards, debit cards, prepaid cards, smart cards (e.g., cards that include one more semiconductor chips, such as memory devices, microprocessors, and microcontrollers), contact cards, contactless cards, proximity cards (e.g., radio frequency (RFID) cards), passports, driver's licenses, welfare cards, network access cards, employee badges, debit cards, security cards, visas, immigration documentation, national ID cards, citizenship cards, social security cards, security badges, certificates, identification cards or documents, voter registration and/or identification cards, police ID cards, border crossing cards, security clearance badges and cards, legal instruments, gun permits, badges, gift certificates or cards, traveler's cards, restaurant cards, membership cards or badges, and tags. Also, the terms “document,” “card,” “badge” and “documentation” are used interchangeably throughout this patent application.). In at least some aspects of the invention, ID document can include any item of value (e.g., currency, bank notes, and checks) where authenticity of the item is important and/or where counterfeiting or fraud is an issue.

In addition, in the foregoing discussion, “identification” at least refers to the use of an ID document to provide identification and/or authentication of a user and/or the ID document itself. For example, in a conventional driver's license, one or more portrait images on the card are intended to show a likeness of the authorized holder of the card. For purposes of identification, at least one portrait on the card (regardless of whether or not the portrait is visible to a human eye without appropriate stimulation) preferably shows an “identification quality” likeness of the holder such that someone viewing the card can determine with reasonable confidence whether the holder of the card actually is the person whose image is on the card. “Identification quality” images, in at least one embodiment of the invention, can include covert images that, when viewed using the proper facilitator (e.g., an appropriate light or temperature source), provide a discernable image that is usable for identification or authentication purposes.

Of course, it is appreciated that certain images may be considered to be “identification quality” if the images are machine readable or recognizable, even if such images do not appear to be “identification quality” to a human eye, whether or not the human eye is assisted by a particular piece of equipment, such as a special light source. For example, in at least one embodiment of the invention, an image or data on an ID document can be considered to be “identification quality” if it has embedded in it machine-readable information (such as digital watermarks or steganographic information) that also facilitate identification and/or authentication.

Further, in at least some embodiments, “identification” and “authentication” are intended to include (in addition to the conventional meanings of these words), functions such as recognition, information, decoration, and any other purpose for which an indicia can be placed upon an article in the article's raw, partially prepared, or final state. Also, instead of ID documents, the inventive techniques can be employed with product tags, product packaging, business cards, bags, charts, maps, labels, etc., etc., particularly those items including marking of an laminate or over-laminate structure. The term ID document thus is broadly defined herein to include these tags, labels, packaging, cards, etc.

“Personalization”, “Personalized data” and “variable” data are used interchangeably herein, and refer at least to data, images, and information that are “personal to” or “specific to” a specific cardholder or group of cardholders. Personalized data can include data that is unique to a specific cardholder (such as biometric information, image information, serial numbers, Social Security Numbers, privileges a cardholder may have, etc.), but is not limited to unique data. Personalized data can include some data, such as birthdate, height, weight, eye color, address, etc., that are personal to a specific cardholder but not necessarily unique to that cardholder (for example, other cardholders might share the same personal data, such as birthdate). In at least some embodiments of the invention, personal/variable data can include some fixed data, as well. For example, in at least some embodiments, personalized data refers to any data that is not pre-printed onto an ID document in advance, so such personalized data can include both data that is cardholder-specific and data that is common to many cardholders. Variable data can, for example, be printed on an information-bearing layer of the ID card using thermal printing ribbons and thermal printheads.

The terms “indicium” and indicia as used herein cover not only markings suitable for human reading, but also markings intended for machine reading. Especially when intended for machine reading, such an indicium need not be visible to the human eye, but may be in the form of a marking visible only under infra-red, ultra-violet or other non-visible radiation. Thus, in at least some embodiments of the invention, an indicium formed on any layer in an identification document (e.g., the core layer) may be partially or wholly in the form of a marking visible only under non-visible radiation. Markings comprising, for example, a visible “dummy” image superposed over a non-visible “real” image intended to be machine read may also be used.

“Laminate” and “overlaminate” include (but are not limited to) film and sheet products. Laminates usable with at least some embodiments of the invention include those which contain substantially transparent polymers and/or substantially transparent adhesives, or which have substantially transparent polymers and/or substantially transparent adhesives as a part of their structure, e.g., as an extruded feature. Examples of potentially usable laminates include at least polyester, polycarbonate, polystyrene, cellulose ester, polyolefin, polysulfone, polyvinyl chloride (PVC), polyethylene, polypropylene, and polyamide. Laminates can be made using either an amorphous or biaxially oriented polymer as well. The laminate can comprise a plurality of separate laminate layers, for example a boundary layer and/or a film layer. Other possibly usable laminates include security laminates, such as a transparent laminate material with proprietary security technology features and processes, which protects documents of value from counterfeiting, data alteration, photo substitution, duplication (including color photocopying), and simulation by use of materials and technologies that are commonly available. Laminates also can include thermosetting materials, such as epoxy. Laminates can include synthetic resin-impregnated or coated base materials composed of successive layers of material, bonded together via heat, pressure, and/or adhesive.

The material(s) from which a laminate is made may be transparent, but need not be. The degree of transparency of the laminate can, for example, be dictated by the information contained within the identification document, the particular colors and/or security features used, etc. The thickness of the laminate layers is not critical, although in some embodiments it may be preferred that the thickness of a laminate layer be about 1-20 mils. Lamination of any laminate layer(s) to any other layer of material (e.g., a core layer) can be accomplished using any conventional lamination process, and such processes are well known to those skilled in the production of articles such as identification documents. Of course, the types and structures of the laminates described herein are provided only by way of example, those skilled in the art will appreciated that many different types of laminates are usable in accordance with the invention. Various lamination processes are disclosed in assignee's U.S. Pat. Nos. 5,783,024, 6,007,660, 6,066,594, and 6,159,327. Other lamination processes are disclosed, e.g., in U.S. Pat. Nos. 6,283,188 and 6,003,581. Each of these U.S. patents is herein incorporated by reference.

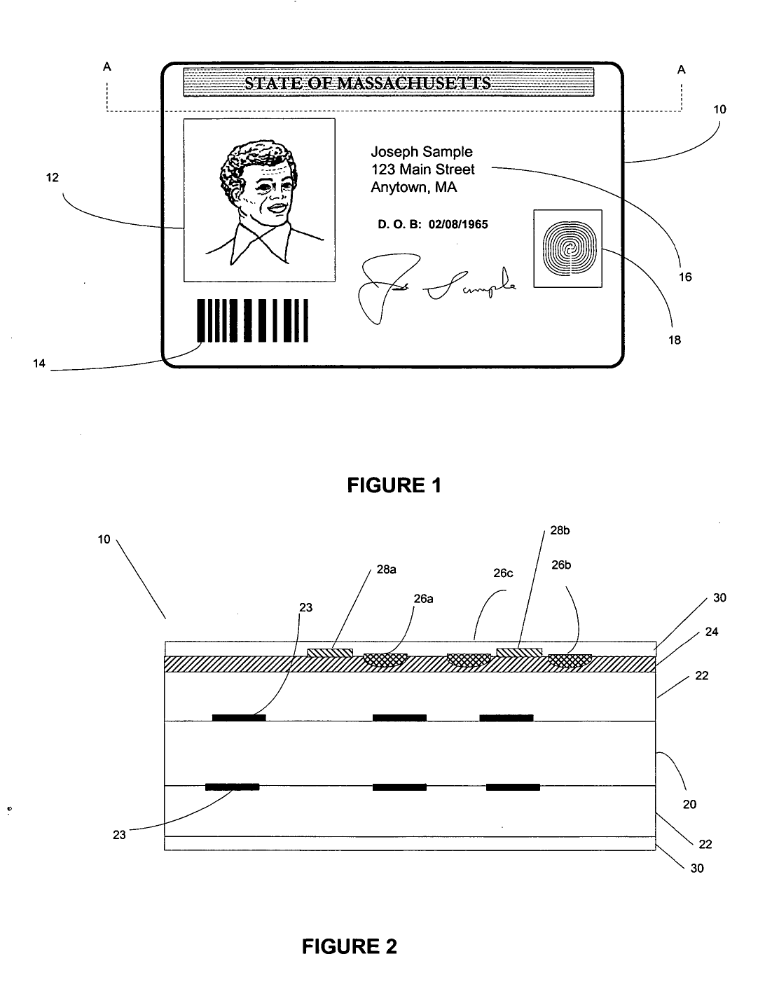

FIGS. 1 and 2 illustrate a front view and cross-sectional view (taken along the A-A line), respectively, of an identification (ID) document 10 in accordance with one embodiment of the invention. In FIG. 1, the ID document 10 includes a photographic image 12, a bar code 14 (which may contain information specific to the person whose image appears in photographic image 12 and/or information that is the same from ID document to ID document), variable personal information 16, such as an address, signature, and/or birthdate, and biometric information 18 associated with the person whose image appears in photographic image 12 (e.g., a fingerprint). Although not illustrated in FIG. 1, the ID document 10 can include a magnetic stripe (which, for example, can be on the rear side (not shown) of the ID document 10), and various security features, such as a security pattern (for example, a printed pattern comprising a tightly printed pattern of finely divided printed and unprinted areas in close proximity to each other, such as a fine-line printed security pattern as is used in the printing of banknote paper, stock certificates, and the like).

Referring to FIG. 2, the ID document 10 of one embodiment of the invention comprises a core 20 (also referred to as a substrate) having two opposing sides. Optionally, the core layer 20 can be pre-printed or laser marked with information 23, such as non-varying or “fixed” information. The preprinting can be accomplished via any desired pre-printing method, lithographic printing, offset printing, silkscreen printing, flexographic printing, gravure printing, etc. The information can, for example, comprise (a) an indicium or indicia, such as the invariant or nonvarying information common to a large number of identification documents, for example the name and logo of the organization issuing the documents; (b) fine line printing, security patterns, guilloche; (c) microtext or microprinting; (c) rainbow text; (d) information printed covert inks (e.g., ultraviolet (UV) and/or infrared (IR) ink, such as the ExianPrime UV offered by the assignee of the present invention, etc. The information may be formed by any known process capable of forming the indicium on the specific core material used.

At least one layer of transparent laminate 22 is coupled to at least one side of the core layer 20. An image receiving layer 24 can be formed on at least one of the transparent laminates 22 on a side that is remote from the core layer 20. The image receiving layer 24 (described in more detail herein) is a layer that is able to be imaged using dye diffusion thermal transfer (D2T2) printing. In the embodiment shown in FIG. 2, first printed indicia 26a-26c are formed on image receiving layer 24 of the identification document 10 via D2T2 printing. As FIG. 2 shows, the indicia are diffused into the image receiving layer 24 due to the nature of the dye and receiving layer, although a small portion can remain slightly raised at the surface.

The identification document 10 of FIG. 2 also shows that second printed indicia 26a-26b are also formed on the image receiving layer 24. These indicia can be formed by so-called thermal or mass transfer printing (some types of D2T2 ribbon, e.g. CMYK ribbons, can include, in addition to the C (cyan), M (magenta) and Y (yellow), panels, a so-called “k” panel that can be used to image solid black via thermal/mass transfer printing 28a-28b.

A relatively thin (e.g. 1-2 mils) layer of overlaminate 30 is coupled to the image receiving layer 24, to protect the printing therein. If desired, the overlaminate 30 can include pre-printed security features, such as covert indicia, holograms, optically variable ink (OVI), etc., as is well understood by those skilled in the art. In one embodiment, the overlaminate 30 comprises the same material as does the core 20 and transparent laminate 22 (e.g., all three layers comprising the same material, e.g. each layer comprising, polycarbonate (PC), polyethylene terephthalate (PET), a composite or blend of two or more plastics, etc.) For PET-based layers, however, it may be difficult to adhere the layers of PET to each other by lamination alone, and a layer of adhesive (not shown) may be necessary.

In at least one embodiment, the core 20 is made from polycarbonate or a polycarbonate-based material (e.g., a composite containing polycarbonate). In other embodiments, the core 20 can also be made of printable polymer materials, such as polyethylene terephthalate (PET), or of printable synthetic paper materials, such as TESLIN. The core 20 has enough opacity to prevent information formed on one side of the core 20 from being visible on the other side of the core 20. For example, known opacifying materials, such as white pigments (e.g., titanium dioxide, zinc oxide, barium sulfate, silica, etc.) can be mixed into the core material. Many different polycarbonates are usable for the core 20 of the invention. We have achieved good results using polycarbonates such as LEXAN 8A13-112 (available from General Electric Plastics of Pittsfield, Mass.) and Bayer Makrofol DPF 5005 polycarbonate (available from Bayer Polymers of Pittsburgh, Pa.). In a preferred embodiment, the polycarbonate core 20 has a sufficiently light color to enable printing and/or laser marking thereon to be visible to an unassisted human eye.

In another preferred embodiment, the core 20 and/or the transparent layer 22 comprises polycarbonate that has added to it one or more laser enhancing additives enabling the resultant identification document containing the core 20 to be laser engraveable or markable or etchable. Examples of usable laser enhancing additives and laser engraving, marking, and etching techniques include the disclosures of following copending and commonly assigned patent applications:
Laser Engraving Methods and Compositions, and Articles Having Laser Engraving Thereon (application Ser. No. 10/326,886, Attorney Docket No. P0724D, filed Dec. 20, 2002—Inventors Brian Labrec and Robert Jones);
Systems, Compositions, and Methods for Full Color Laser Engraving of ID Documents (application Ser. No. 10/330,034, Attorney Docket No. P0734D, filed Dec. 24, 2002—Inventor Robert Jones);
Laser Engraving Methods and Compositions, and Articles Having Laser Engraving Thereon,” (application Ser. No. 10/326,886, filed Dec. 20, 2002, attorney docket number P0724D, filed Mar. 17, 2004, inventors Robert Jones and Brian Labrec);
Laser Engraving Methods and Compositions and Articles Having Laser Engraving Thereon (application Ser. No. 10/803,538, Attorney Docket No. P0952D—Inventor Brian Labrec);
Laser Engraving Methods and Compositions and Articles Having Laser Engraving Thereon (Application No. 60/504352, Attorney Docket No. P0888D, filed Sep. 19, 2003—Inventors Brian Labrec and Robert Jones); and
Increasing Thermal Conductivity of Host Polymer Used with Laser Engraving Methods and Compositions (application Ser. No. 10/677,092, Attorney Docket No. P0889D, filed Sep. 30, 2003)

The contents of these patent applications are hereby incorporated by reference. The content of these patent applications, collectively, is referred to herein as the “laser additive applications”. Those of skill in the art will appreciate that other types of laser engraving additives are also usable in the core 20 of the invention.

The core 20 is laminated on either side with a transparent layer 22 of substantially transparent material, such as polycarbonate, polypropylene, ABS copolyester, and/or other thermal plastics. We have found that an advantageous card construction can be created when both the core 20 and the transparent layer 22 are made of (or consist essentially of) the same material, e.g. both layers comprising polycarbonate or both layers comprising a thermal plastic such as polypropylene and/or ABS copolyester. In one embodiment, because the core layer 20 and transparent layer 22 are both made of polycarbonate, fixation of the transparent layer 22 to the core layer 20 may be effected by heat and pressure alone (or other known lamination methods). This can greatly increase the strength of the card and can help to prevent or reduce delamination and/or tampering.

The material of the transparent layer 22 can be similar to the materials used for the core layer 20, but generally the transparent layer 22 will differ from the core layer 20 in that the core layer 20 is preferably substantially opaque, whereas the transparent layer 22 is substantially transparent.

Of course, in another embodiment, it is possible to provide an adhesive layer (not shown in FIG. 2) to couple either or both transparent layers 22 to the core layer 20 to improve their adhesion to the core layer. This adhesive layer may be a polyester, polyester urethane, polyether urethane or polyolefin hot melt or ultraviolet or thermally cured adhesive, and the adhesive may be coated, cast or extruded on to one surface of the transparent layer 22. Adhesive layers also can be provided that provide evidence of intrusion during an attempted delamination; an example of such an adhesive is described in commonly assigned patent application Ser. No. 60/552172, entitled “Tamper Evident Adhesive and Identification Document Including Same,” filed Mar. 11, 2004, the contents of which are hereby incorporated by reference.

The thickness of the core 20 depends at least in part on the desired thickness of the overall identification document 10 and/or the thickness of any laminates, coatings, and/or overlaminates used on the identification document 10. In one embodiment, the core 20 is about 25 mils thick, but this thickness is not, of course, limiting. For a typical identification document such as a standard identification card (e.g., a driver's license), the overall thickness can, for example, range from 27-33 mils.

After the laminate layer 22 is coupled to the core layer 20 (e.g., by heat and/or pressure, such as by press lamination), an image receiving layer 24 is formed over the transparent layer 22. The image-receiving layer 24 of the present identification document may be formed from any material capable of receiving an image by dye diffusion thermal transfer and which is not miscible with the adjacent layers. In one embodiment, we have formed an image receiving layer 24 by applying a coating to the combination of the laminate layer 22 and core layer 20. This coating can, in one embodiment, be created by mixing about 5-20% (e.g., about 10%) of a low density poly vinyl chloride (PVC) (e.g., Oxy 155 available from Occidental Chemical Corporation of Dallas, Tex.) together with about 80-95% (e.g., about 90%) of a solvent, preferably a non-toxic organic solvent such as methyl ethyl ketone, ethyl acetate, n-propyl acetate, tolulene, dichloromethane, etc. Other additive can also be mixed into this coating, such as 0.5-5% of silica, 0.1-1% of a surfactant, etc. We have found that the coating formulation described above can be especially advantageous because it is stable under press lamination. Thus, referring

In one embodiment, we employ gravure and slot coating to apply the image receiving layer 24. Other coating methods known to those of skill in the art can, of course, be used (e.g., gravure coating, extrusion casting, patch coating, slid coating, hand coating with Meyer rod, continuous web coating, hot melt coating, spray coating, dip coating, immersion, brushing, rolling, etc. We have achieved coating thicknesses ranging from 0.5 microns to about 5 microns, although we have found that in some embodiments a coating thickness of about 2 microns is preferred. The coating forming the image receiving layer 24 can be applied by coating method known to those in the art.

In one embodiment, the dye diffusion thermal transfer printing step of the present process is affected by the process of U.S. Pat. No. 5,334,573. This patent describes a receiving sheet or layer which is comprised of a polymer system of which at least one polymer is capable of receiving image-forming materials from a donor sheet upon the application of heat thereto, the polymer system of the receiving sheet or layer being incompatible or immiscible with the polymer of the donor sheet at the receiving sheet/donor sheet interface so that there is no adhesion between the donor sheet and the receiving sheet or layer during printing. In addition, the polymer system of the receiving sheet or layer can be substantially free from release agents, such as silicone-based oils, poly(organosiloxanes), fluorinated polymers, fluorine- or phosphate-containing surfactants, fatty acid surfactants and waxes.

The present process for printing may employ any of the donor sheet/image-receiving layer combinations described in this patent. Suitable binder materials for the dyes which are immiscible with the polymer system of the image-receiving layer include cellulose resins, cellulose acetate butyrate, vinyl resins such as poly(vinyl alcohol), poly(vinylpyrrolidone) poly(vinyl acetate), vinyl alcohol/vinyl butyrate copolymers and polyesters.

In one embodiment of the invention, polymers which can be used in the image-receiving layer and which are immiscible with the aforementioned donor binders include polyester, polyacrylate, polycarbonate, poly(4-vinylpyridine), poly(vinyl acetate), polystyrene and its copolymers, polyurethane, polyamide, poly(vinyl chloride), polyacrylonitrile, or a polymeric liquid crystal resin. The most common image-receiving layer polymers are polyester, polycaprolactone and poly(vinyl chloride). As we discussed previously above, our preferred receiving layer for D2T2 printing includes poly vinyl chloride.

Additional processes for forming such image-receiving layers are also described in detail in the '573 patent described above. As we discus previously, we can dissolve the PVC into an appropriate solvent. Generally, in accordance with at least some embodiments of the invention, the polymer(s) used to form the image-receiving layer are dissolved in an organic solvent, such as methyl ethyl ketone, dichloromethane or chloroform, and the resultant solution can be coated on to the polymer layer using conventional coating apparatus, and the solvent evaporated to form the image-receiving layer. However, if desired the image-receiving layer can be applied to the polymer layer by extrusion casting, or by slot, gravure or other known coating methods.

Thus, in at least some embodiments of the invention the image-receiving layer 24 can be produced by a one-step process, and since no post-coating crosslinking is necessary, the dye densities in the image eventually formed upon the image-receiving layer are not compromised. Furthermore, since no heat other than the moderate heat required to transfer the dye from the donor sheet to the image-receiving layer and to dry the image on this layer is needed, thermal distortion of the core and polymer layers is avoided. Also, since the polymer systems described in U.S. Pat. No. 5,334,573 lack a silicone oil or other low surface energy release agent, lamination of the image-receiving layer to other materials is facilitated.

The identification documents 10 of this embodiment of the invention may include only a single image-receiving layer (as shown in FIG. 2). In some embodiments, however, it may be preferable that the identification document 10 have two image-receiving layers. One such image receiving layer can be provided on each transparent layer 22 on the side of the transparent layer that is remote from the core layer 20. In one example embodiment, one or more first indicia 26a-26c (such as indicia intended for human reading) may be printed on the image-receiving layer 24 on the front side of the identification document 10, and one or more additional indicia (not shown) intended for machine reading (for example, bar codes, magnetic stripes) may be printed on an image-receiving layer on the back side of the identification document 10.

The composite of the core 20 and the transparent layer 22 and the image receiving layer 24 form a so-called “card blank that can be, for example, around 27-27 mils thick (typically around 30 mils thick). As described above, first indicia 26a-c (which can, for example, be variable or personalized indicia) are printed on the card blank 25 using a method such as Dye Diffusion Thermal Transfer (“D2T2”) printing (described further below and also in commonly assigned U.S. Pat. No. 6,066,594, which is incorporated hereto by reference in its entirety.) The information 26a-d can, for example, comprise an indicium or indicia, such as the invariant or nonvarying information common to a large number of identification documents, for example the name and logo of the organization issuing the documents. The information 26a-d may be formed by any known process capable of forming the indicium on the specific core material used.

An additional layer of overlaminate 30 can be coupled to the card blank and printing 26a-c using, for example, 1 mil of overlaminate. The overlaminate 24 can be substantially transparent. Materials suitable for forming such protective layers are known to those skilled in the art of making identification documents and any of the conventional materials may be used provided they have sufficient transparency. Examples of usable materials for overlaminates include biaxially oriented polyester or other optically clear durable plastic film, as well as any polymer having sufficient transparency, for example polyester, polycarbonate; polystyrene, cellulose ester, polyolefin, polysulfone, or polyimide. In a preferred embodiment, the overlaminate 24 comprises the same material as the transparent layer 22. For example, in one embodiment, the overlaminate 24 comprises polycarbonate, such that the ID document 10 is substantially an “all polycarbonate” card.

As already mentioned, in the process of the present invention, an optional the first step is forming a first indicium 23 upon the core layer 20. The first indicium or indicia 23, which are typically the invariant information common to a large number of identification documents, for example the name and logo of the organization issuing the documents, may be formed by any known process capable of forming the indicium on the specific core material used (e.g., laser xerography, Indigo, intaglio, laser engraving or marking, inkjet printing, thermal or mass transfer printing, etc.

In at least some embodiments of the invention, a large sheet of core layer 20 is provided that will be eventually cut (e.g., via die-cutting) into a plurality of “card blanks,” and in this example it is usually desired to provide numerous copies of the first indicium 23 on a large area of core layer material 20 (in the form of a large sheet or web), such as in an array of such copies of the first indicium 23, in order to allow the preparation of a large number of “blank” documents at one time. With such a process of printing a large number of documents at once, a printing process such as color laser printing or Indigo printing may be preferred to print the first indicium 23. A modified laser printer useful for forming the first indicium 23 in the present process is described in U.S. Pat. No. 5,579,694.

If desired, first indicia 23 may be provided on both surfaces of the core layer 20 (as shown in FIG. 2). For example, it is often convenient to provide one or more first indicia 23 intended for human reading of the core layer surface which becomes the front of the completed identification document, and one or more additional first indicia intended for machine reading (e.g., bar codes) on the opposed “back” surface of the core layer. As those skilled in the art will appreciate, different mechanisms can be used to print the first indicia 23 appearing on the front of the cards as compared to the first indicia 23 appearing on the back of the cards.

Note that the term “indicium” as used herein to cover not only markings suitable for human reading, but also markings intended for machine reading. Especially when intended for machine reading, such an indicium need not be visible to the human eye, but may be in the form of a marking visible only under infra-red, ultra-violet or other non-visible radiation. Thus, the first indicium on the core layer of the present identification document (and the second indicium discussed below) may be partially or wholly in the form of a marking visible only under non-visible radiation. Markings comprising, for example, a visible “dummy” image superposed over a non-visible “real” image intended to be machine read may also be used.

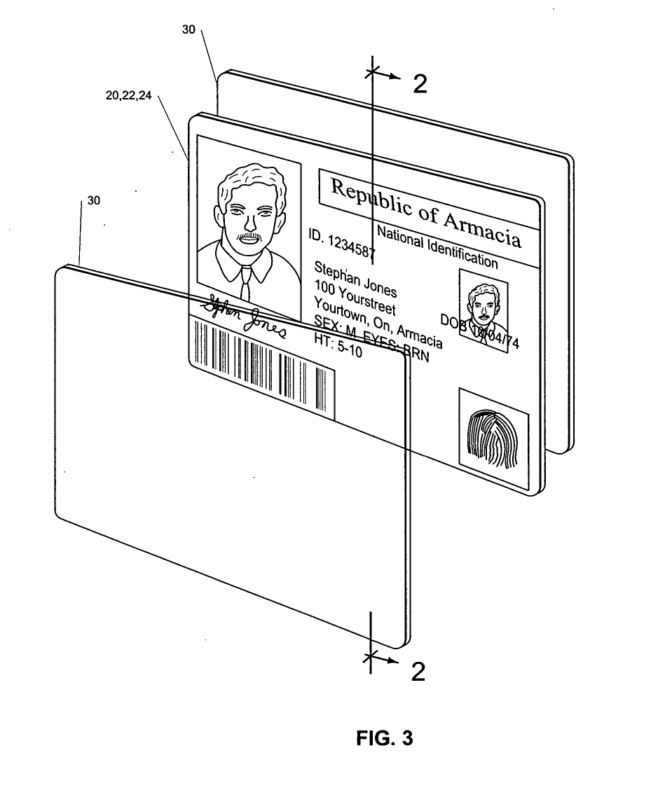

In one embodiment, it can be convenient to carry out the processes in accordance with the invention by printing numerous copies of the first indicium 23 on a large area of the core layer material 20 in the form of a sheet or web. The transparent layer 22 layer and the image-receiving layer or layers 24 can then be provided on the core layer 20 using films of substantially the same size and shape as that of the core layer material 20 and/or via a coating process that can coat the entire large sheet or web at once. The completed sheet or web can then be divided into a plurality of sections each bearing one copy of the first indicium to provide a plurality of “blank” identification documents ready for dye diffusion thermal transfer printing. FIG. 3 illustrates, in exploded perspective view, a so called “card blank” (comprising core layer 20, transparent layers 22, and image receiving layer 24) as it is disposed between the layers of overlaminate 30.

The aforementioned steps for production of a card blank advantageously are carried out at a secure central production facility and the resultant “blank” documents shipped as required to a plurality of document issue stations at which variable data are applied to the image-receiving layers of the identification documents and the protective layers are laminated over the image-receiving layers.

Of course, the batch production techniques described above are not the only way to produce the identification document 10. The identification documents 10 can, of course, be produced one at a time, as part of a continuous roll, etc.

The identification documents of the invention may be manufactured in any desired size. For example, in at least some embodiments, such documents will range in size from standard business card size (47.6.times.85.7 mm) up to identification booklet documents (127.times.177.8 mm), and will have thicknesses in the range of from about 0.3 to about 1.3 mm. Most commonly, credit cards and driving licenses produced in accordance with at least some embodiments of the invention will conform to all the requirements of ISO 7810, 1985 and will thus be of the CR-80 size, 85.47-85.73 mm wide, 53.92-54.03 mm high and 0.69-0.84 mm thick. The corners of such CR-80 documents should be rounded with a radius of 2.88-3.48 mm and care should be taken to avoid misalignment between the rounded corners and the straight edges of the card. The maximum distance from a flat, rigid plate to any portion of the convex surface of an unembossed card should not be greater than 1.5 mm, including the thickness of the card.

FIGS. 1-3 and their associated description reference a document having an image receiving layer 24 where the image receiving layer 24 is one that is receptive to D2T2 type printing. Those skilled in the art will appreciate, however that image receiving layers associated with other types of printing technologies can also be used to adapt the identification document 10 to be printable using those technologies. For example, the image receiving layer can be a layer adapted to receive inkjet printing, a layer adapted to be receptive to engraving (e.g., layer containing one of the aforementioned laser enhancing additives described in one or more of the laser additive applications), etc.

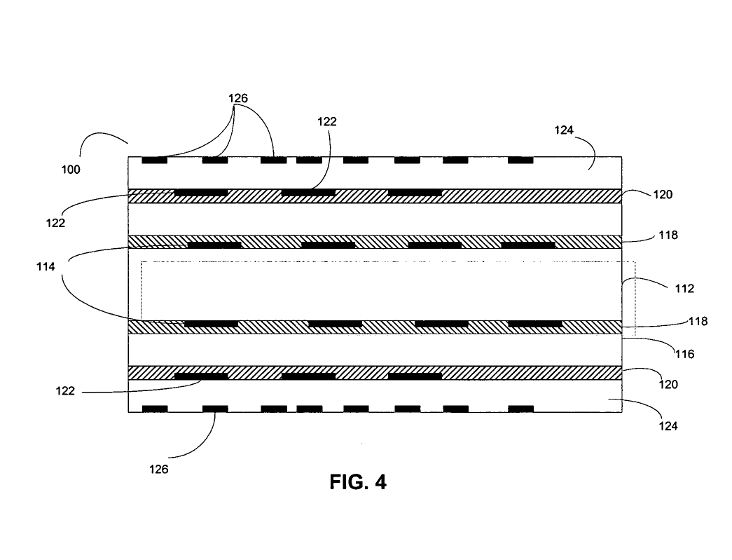

FIG. 4 shows schematically a cross-section through a finished identification document 100 in accordance with still another embodiment of the invention. The document, generally designated 100, comprises a core layer 112 formed of a substantially opaque, light colored material. For example, in one embodiment, the core layer comprises a white reflective polyolefin, such as TESLIN, and is printed on both surfaces with fixed indicia 114. In another embodiment, the core layer comprises a substantially opaque, light colored polymer material, such as PC or PET or PET-G.

The printed core layer 112 is sandwiched between two transparent layers 116 formed from a material such as polycarbonate or PET. Each of these polymer layers 116 is fixedly secured to the core layer 112 by a layer 118 of adhesive 118. On the opposed side of each polymer layer 116 from the core 112 is provided an image-receiving layer 120 suited to the acceptance of printed image or portrait or other variable indicia (indicated schematically at 122) by dye diffusion thermal transfer (D2T2) methods. The material used to form the image-receiving layers 120 is chosen so as to be immiscible with the polymer system of the donor sheet used, in accordance with the aforementioned U.S. Pat. No. 5,334,573.

After the variable indicia 122 have been printed on the image-receiving layers 120, a substantially optically clear durable plastic protective layer 124 is applied to protect the variable indicia and prevent bleeding of dye from the image-receiving layers 120. In one embodiment, the protective layer 124 comprises polycarbonate. The protective layer 124 may be provided with a low cohesivity layer, security ink or other security feature, as indicated schematically at 126.

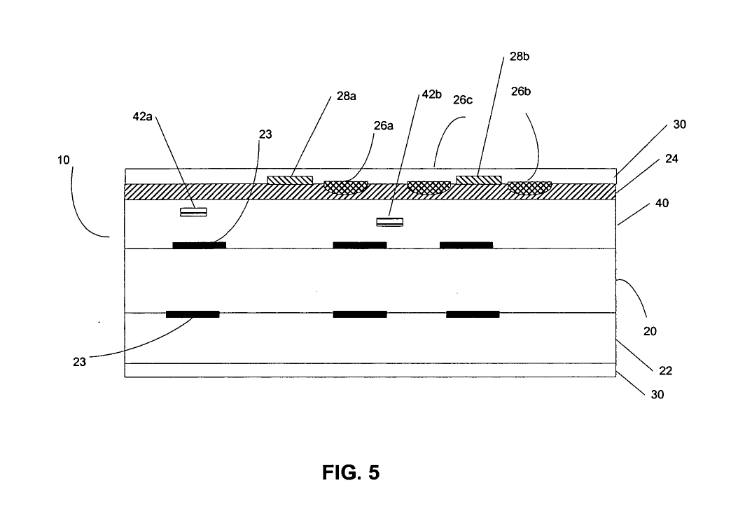

FIG. 5 is an illustrative cross sectional view of an identification document 10 in accordance with a third embodiment of the invention, where the identification document 10 is at least partially imaged via laser engraving. The identification document 10 of FIG. 5 includes a core layer 20 which is substantially similar to the core layer 20 of FIG. 2 and can be made using the same materials. In this example, the core layer has been pre-printed with fixed indicia 23. A first side (in this example, the bottom side) of the core layer 20 is coupled to a first sheet of transparent laminate 22, where the first sheet of transparent laminate 22 is substantially similar to the transparent laminate 22 of FIG. 2 and can be made using the same materials. A second side (in this example, the top side) of the core layer is coupled to a second sheet of transparent laminate 40, where the second sheet of transparent laminate is either a material that is already receptive to laser engraving or is a material that has a laser enhancing additive (e.g., one or more of the laser additives described in the aforementioned laser additive applications) added to it. Thus, the second transparent laminate 40 can have laser engraved indicia 42a-24b formed therein or thereon.

An image receiving layer 24 is formed on the other side of the second sheet of transparent laminate 24. The image receiving layer 24 of FIG. 5 is substantially similar to the image receiving layer 24 of FIG. 2 and can be made using the same materials. The formation of indicia via D2T2 on the image receiving layer 24 of FIG. 5 is substantially similar to what was described previously in connection with FIG. 2.

The laser engraved indicia 42a-24b can comprise variable information and/or fixed information, and can be laser engraved to the second transparent laminate 40 at virtually any time. In particular, the laser engraving can occur before or after the image receiving layer 24 (that is, the laser can penetrate through the image receiving layer 24 to engrave the second transparent layer.) Note also, that the overlaminate 30 can, if desired, include a low cohesivity layer, security ink or other security feature, as was indicated schematically at for the overlaminate 124 of FIG. 4.

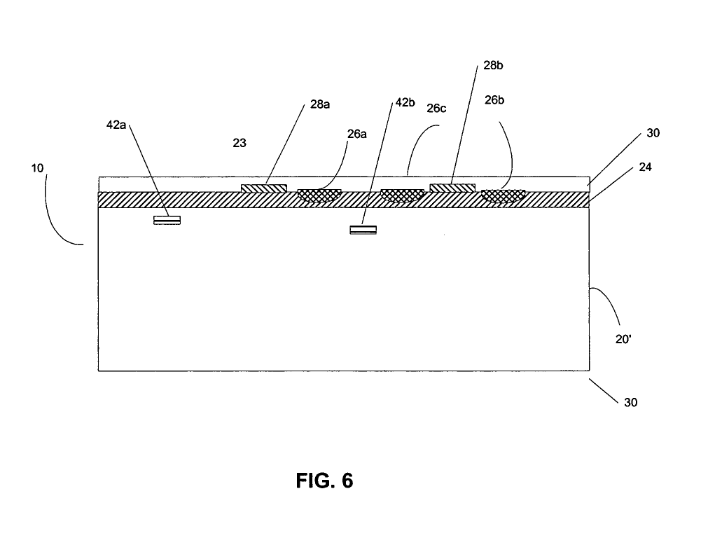

FIG. 6 is an illustrative cross-sectional view of an identification document 10 in accordance with a fourth embodiment of the invention. In this example, the identification document 10 includes a laser engraveable core 20′ but does not require transparent layers. Instead, the image receiving layer 24 is coupled directly to the laser engraveable core 20′. The laser engraveable core 20′ itself is a solid piece of material (e.g., PET or PC) that is sensitive to laser engraving (such as by the addition of one or more laser additives such as those described in the aforementioned laser additive applications). Advantageously, the laser engraveable core 20′ is formed from a substantially opaque material, so that information formed on one side is not visible on the other side.

The laser engraved indicia 42a-42b can comprise variable information and/or fixed information, and can be laser engraved to the laser engraveable core 20′ second transparent laminate 40 at virtually any time. In particular, the laser engraving can occur before or after the image receiving layer 24 (that is, the laser can penetrate through the image receiving layer 24 to engrave the second transparent layer.). The image receiving layer 24 (which is similar to those previously described herein) is coated to one side of the laser engraveable core 20′. The formation of indicia via D2T2 on the image receiving layer 24 of FIG. 5 is substantially similar to what was described previously in connection with FIG. 2.

Embodiments of the invention described herein can provide numerous advantages for the production of ID documents such as driver's licenses. For example, in one embodiment, the invention provides a card architecture that combines two of the world's most well known advanced card materials in one card formulation: polycarbonate (PC) and TESLIN materials. TESLIN forms the core of this premium card and can carry with it, all of the preprinted high end graphics and security features available currently available. Additionally, many of the security features referenced in the earlier mentioned patents can be incorporated into the core layer of at least some embodiments of the invention. In one embodiment, use of materials such as polycarbonate for the transparent layers and/or the overlaminate can provide maximum protection for the security features and for any graphics (e.g., currency grade printed graphics) within the core of the card.

One or both sides of an identification document constructed in accordance with at least some embodiments of the invention can be fully capable of being imaged with variable color images, text and other data. For example in an OTC environment, at least one embodiment of the invention can present one side of the card as a receptor for D2T2 dyes for beautiful, crisp full color imaging and the other side is designed to accept typical K panel (black) for text or bar code printing. Because high grade polycarbonate can be used for at least some embodiments, the card's surfaces can be extremely smooth and defect free resulting in consistently high quality levels of printing on both sides. Defects that can typify composite and PVC cards such as drop outs and white spots can be substantially eliminated.

At least some cards manufactured in accordance with some embodiments of the invention further provide advantages such as image destruct upon intrusion attempts, exceeding card integrity or severe service requirements of ANSI/ISO/AAMVA tests and full 10 year actual field life.

In at least one embodiment, ID documents manufactured in accordance with the invention can be made in a secure manufacturing location under direct manufacturer control, to enhance security of materials and processes. In a further embodiment, the ID document manufactured in accordance with the invention further comprises technology such as EIN (Embedded Inventory Control Numbers) to guarantee the authenticity and traceability of each and every card. An illustrative example of such EIN technology is described in a commonly assigned patent application Ser. No. 60/529847, entitled “Inventory Management System and Methods for Secure Identification Document Issuance,” the contents of which are hereby incorporated by reference. With such technology, every card blank can be traced/managed from its birth to its grave.

ID documents manufactured in accordance with at least one embodiment of the invention may help to reduce or eliminate thermal shrinkage that can be found in PVC and/or so-called Composite cards. For example, at least some embodiments of the invention can help to reduce or eliminate so-called “potato chipped” (severely bent or twisted) cards, because the polycarbonate materials have thermal activation points far above the lamination temperatures required and thus no thermal distortion of the card materials results. Potato chip cards can be a major problem generated by laminating protective layers to OTC cards.

Another advantage of at least some embodiments of the invention is durability. Durability can be enhanced with at least some of the disclosed embodiments of identification document architectures since use polycarbonate material is not prone to stress fracture nor does it suffer from “form stress relief”. Stress fracture occurs with a PVC containing card since PVC polymers stress craze and ultimately yield by cracking. “Form stress relief” occurs when a identification document such as a card is forced into an unnatural form or shape (such as in a wallet) for extended periods of time and then is suddenly forced to take on a different shape by handling. Like unleashing a coiled spring, PVC and Composite cards simply crack. Polycarbonate has neither of these properties and therefore cards manufactured in accordance with at least some embodiments of the invention can live comfortably through all of the rigors such cards are exposed to in normal and abnormal field use.

Polycarbonate also can be totally immune to all crystallization phenomena and as such, represents an improvement over all amorphous polyester based ID document products. Exposure to extended heats and/or solvents present can, for example, present danger to some types of ID documents, but at least some embodiments of the present invention are substantially immune to the problems of heat and/or solvent exposure, which can yield an advance in document durability.

As noted previously, at least some embodiments of the invention provide ID documents that are laser engrave-able and/or laser markable and/or laser etchable. In at least some embodiment, adding laser capability requires a relatively minor change in the polycarbonate formulation. Further, the assignees patent pending sensitization formulas (disclosed, for example, in the aforementioned laser additive applications), can provide ID documents constructed in accordance with the invention with advanced laser capability.

In a further embodiment, the ID card structures disclosed herein are smart chip capable. For example, at least some embodiments of the invention provide an ID document that can be drilled and filled with any contact chip desired. The above-described laser and smart-card aspects of the invention are advances over PVC, PVC Composite card and many other known cards.

A further advantage of at least so me embodiments of the invention are enhancing of OTC printer/device card feeding and handling. The stability of the components combines to form a very stable and flat card with extremely uniform surfaces and dimensions. Thus, ID documents manufactured in accordance with some embodiments of the invention are compatible with a great number of OTC printers is a given, including Eltron, Atlantek, Nisca, and Fargo desktop printers. Because the ID documents of at least some embodiments of the invention include an image receiving layer, printer setting adjustments are necessary to achieve desired color balance and text crispness. This represents yet another differentiator in that, at least some embodiments of the invention can help to thwart counterfeit activities using non-standard printers.

Additionally embodiments of the invention which do not use PVC help to provide products that are more environmentally friendly than many existing PVC-based products.

Referring again to FIG. 2, heat, pressure, and/or adhesive can used to bond the transparent laminate layers 22 to the core layer 20. The adhesive can even be coated or provided on a substrate-engaging side of the transparent laminate layers 22. These laminate layers 22 also can provided in the form of a pouch into which the core layer 20 slips. Again, heat, pressure, and/or adhesives would be used to bond the core layer 20 to the pouch laminate. Generally, for at least some embodiments of the invention, a preferred finished ID document includes at least a three-layer structure (e.g., laminate-core-laminate). The lamination provides a protective covering for the printed substrates and provides a level of protection against unauthorized tampering. (For example, a laminate would have to be removed to alter the printed information and then subsequently replaced after the alteration.). Various lamination processes are disclosed in assignee's U.S. Pat. Nos. 5,783,024, 6,007,660 and 6,159,327. Other lamination processes are disclosed, e.g., in U.S. Pat. Nos. 6,283,188 and 6,003,581. Each of these U.S. patents is herein incorporated by reference. Our present disclosure provides improvements over these lamination techniques.

At least one embodiment (e.g., see FIG. 6), includes a finished ID document structure that is at least a two layer structure (core-image receiving layer), with an optional overlaminate over the image receiving layer.

Any or all of the printed information and/or images on the substrate may also include one or more built in security features, as well, to help reduce identity fraud. For example, in one embodiment of the invention, portions of the ID document 10, such as an image or a bar code, can include a digital watermark. Digital watermarking is a process for modifying physical or electronic media to embed a machine-readable code therein. The media may be modified such that the embedded code is imperceptible or nearly imperceptible to the user, yet may be detected through an automated detection process. The code may be embedded, e.g., in a photograph, text, graphic, image, substrate or laminate texture, and/or a background pattern or tint of the photo-identification document. The code can even be conveyed through ultraviolet or infrared inks and dyes.

Digital watermarking systems typically have two primary components: an encoder that embeds the digital watermark in a host media signal, and a decoder that detects and reads the embedded digital watermark from a signal suspected of containing a digital watermark. The encoder embeds a digital watermark by altering a host media signal. To illustrate, if the host media signal includes a photograph, the digital watermark can be embedded in the photograph, and the embedded photograph can be printed on a photo-identification document. The decoding component analyzes a suspect signal to detect whether a digital watermark is present. In applications where the digital watermark encodes information (e.g., a unique identifier), the decoding component extracts this information from the detected digital watermark.

Several particular digital waternarking techniques have been developed. The reader is presumed to be familiar with the literature in this field. Particular techniques for embedding and detecting imperceptible watermarks in media are detailed, e.g., in Digimarc's co-pending U.S. patent application Ser. No. 09/503,881 and U.S. Pat. No. 6,122,403. Techniques for embedding digital watermarks in identification documents are even further detailed, e.g., in Digimarc's co-pending U.S. patent application Ser. Nos. 10/094,593, filed Mar. 6, 2002, and 10/170,223, filed Jun. 10, 2002, co-pending U.S. Provisional Patent Application No. 60/358,321, filed Feb. 19, 2002, and U.S. Pat. No. 5,841,886. Each of the above-mentioned U.S. patent documents is herein incorporated by reference.

### Concluding Remarks

Having described and illustrated the principles of the technology with reference to specific implementations, it will be recognized that the technology can be implemented in many other, different, forms, and in many different environments.

For example, we note that at least some embodiments, our preferred laminate material is polymer-based and typically softens at a temperature required to soften and activate a laminate adhesive. This softening point is an excellent feature in a finished ID card because it makes tampering with the card evident due to the stretching and distortion of the laminate that occurs when heat is used to try to remove the laminate. Accordingly, a laminator will sometimes deal with the stretching and distortion aspect and, therefore, we have introduced the concepts of belts, cooling rollers or special pouch carriers. Of course, these elements can be simplified if laminates, which use a base polymer that does not soften at the adhesive laminating temperature, are used instead. The tradeoff, however, is that tamper resistance of a finished card will likely be inferior.

While we have provided some specific dimensions for the card and laminate material, the present invention is not limited to such. Dimensional changes can be made without deviating from the scope of our invention.

To provide a comprehensive disclosure without unduly lengthening the specification, applicant herein incorporates by reference each of the U.S. patent documents referenced herein.

The particular combinations of elements and features in the above-detailed embodiments are exemplary only; the interchanging and substitution of these teachings with other teachings in this and the incorporated-by-reference patent documents are also expressly contemplated. Further, although certain words, languages, phrases, terminology, and product brands have been used herein to describe the various features of the embodiments of the invention, their use is not intended as limiting. Use of a given word, phrase, language, terminology, or product brand is intended to include all grammatical, literal, scientific, technical, and functional equivalents.

As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto.

1. An identification document comprising:
a core layer, the core layer having first and second sides and comprising at least one of polycarbonate (PC) and polyethylene terephthalate (PET);
a substantially transparent layer fixed to the first side of the core layer, the substantially transparent layer having first and second sides and affixed to the core layer along the first side of the substantially transparent layer, the substantially transparent layer comprising at least one of PC and PET; and
an image-receiving layer capable of being imaged by dye diffusion thermal transfer, the image-receiving layer being fixed to the second side of the substantially transparent layer.

2. The identification document of claim 1, wherein the image receiving layer comprises polyvinyl chloride.

3. The identification document of claim 1, wherein the image receiving layer is applied as a coating.

4. The identification document of claim 3, wherein the coating comprises about 5-20% low density PVC mixed with about 80-95% of a solvent.

5. The identification document of claim 1 wherein the core layer has a first indicium formed thereon.

6. The identification document of claim 1 having at least one second indicium printed by dye diffusion thermal transfer on the image-receiving layer.

7. The identification document of claim 5, having at least one second indicium printed by dye diffusion thermal transfer on the image-receiving layer, the second indicium being different from the first indicium on the core layer.

8. The identification document of claim 7, wherein at least one of the first and second indicia comprises fixed data and the other comprises variable data.

9. The identification document of claim 1 further comprising a protective layer fixed to the image-receiving layer and superposed over the second indicium thereon.

10. The identification document of claim 5 wherein the indicium on the core layer is formed by at least one of laser engraving, laser marking, and laser etching.

11. The identification document of claim 1 wherein the substantially transparent layer has an indicium formed therein, the indicium formed by at least one of laser engraving, laser marking, and laser etching.

12. A process for preparing an identification document, which process comprises:
providing a core layer, the core layer having first and second sides and comprising at least one of polycarbonate (PC) and polyethylene terephthalate (PET);
affixing to the first side of the core layer a substantially transparent layer, the substantially transparent layer having first and second sides and affixed to the core layer along the first side of the substantially transparent layer, the substantially transparent layer comprising at least one of PC and PET; and
applying to the second side of the substantially transparent layer an image-receiving layer capable of being imaged by dye diffusion thermal transfer.

13. The process of claim 12, further comprising printing a first indicia to the core layer.

14. The process of claim 12, further comprising printing a second indicia to the image receiving layer by dye diffusion thermal transfer.

15. The process of claim 13 further comprising printing a second indicia to the image receiving layer by dye diffusion thermal transfer.

16. The process of claim 13 wherein at least one of the first and second indicia comprises fixed data and the other comprises variable data.

17. The process of claim 13 wherein the indicia is formed by at least one of laser engraving, laser etching, and laser marking.

18. The process of claim 14, further comprising affixing a protective layer over the image-receiving layer bearing the second indicium.

19. The process of claim 6, further comprising forming at least a third indicium within the substantially transparent layer by at least one of laser engraving, laser marking, and laser etching.

20. An identification document, comprising:
a core layer, the core layer having first and second sides and comprising at least one of polycarbonate and polyethylene terephthalate; and
an image-receiving layer capable of being imaged by dye diffusion thermal transfer, the image-receiving layer being fixed to at least one of the first and second sides of the core layer.

21. The identification document of claim 20, wherein the core layer is capable of being imaged by at least one of laser engraving, laser marking, and laser etching.

22. The identification document of claim 20, wherein the core layer has a first indicia formed therein.

23. The identification document of claim 22, wherein the image layer as a second indicia formed therein, wherein the second indicia differs from the first indicia.

24. The identification document of claim 23, wherein at least one of the first and second indicia comprises variable data.
